(19) United States
(12) Patent Application Publication
(10) Pub. No.: US 2019/0057410 A1
(43) Pub. Date: Feb. 21, 2019

(54) TOOL FOR DETERMINING REAL ESTATE MARKET CLEARING PRICE

(71) Applicant: CARRIER CORPORATION, Palm Beach Gardens, FL (US)

(72) Inventor: Tony Spath, West Hartford, CT (US)

(21) Appl. No.: 16/104,175

(22) Filed: Aug. 17, 2018

Related U.S. Application Data
(60) Provisional application No. 62/546,881, filed on Aug. 17, 2017.

(51) Int. Cl. G06Q 30/02

(52) U.S. Cl. CPC G06Q 30/0206; G06Q 30/0283; G06Q 50/16; G06Q 30/0201; G06Q 30/0205

(57) ABSTRACT

A method of estimating a price for a desired property comprising: receiving a real estate price estimate request; determining a search area; obtaining sales data for one or more first properties sold in the search area within a first selected time period, wherein the sales data includes an initial list price, a purchase price, and an average attractiveness score for each of the one or more first properties; obtaining sales data for one or more second properties; determining a projected change in price percentage in response to the sales data for the one or more first properties and second properties; determining a first supply score; determining a second supply score; and determining an estimated market clearing price for the desired property in response to an initial listing price of the desired property, the first supply score, the second supply score, and the projected change in price percentage.

### CROSS-REFERENCE TO RELATED APPLICATIONS

This application claims priority to and the benefit of U.S. Provisional Patent Application Ser. No. 62/546,881, filed on Aug. 17, 2017, and all the benefits accruing therefrom under 35 U.S.C. § 119, the content of which is incorporated herein in its entirety by reference.

### BACKGROUND

The subject matter disclosed herein generally relates to real estate searching systems, and more particularly, to a system and method of estimating property values.

Estimating home prices is often difficult as it may include many intangibles that are hard to quantify for buyers unfamiliar with the home market in the area. This could make the home buying experience stressful and may also often lead to feelings of buyer's remorse, with buyers not knowing whether they received a good price for the home they just purchased in comparison to the current home market in the area.

### BRIEF SUMMARY

According to one embodiment, a method of estimating a price for a desired property is provided, the method comprising: receiving a real estate price estimate request from a real estate application operating on a user device of the buyer, the real estate price estimate request including a desired property; determining a search area in response to a geographical location of the desired property; obtaining sales data for one or more first properties sold in the search area within a first selected time period, wherein the sales data includes an initial list price, a purchase price, and an average attractiveness score for each of the one or more first properties; obtaining sales data for one or more second properties sold in the search area within a second selected time period, wherein the sales data includes an initial list price, a purchase price, and an average attractiveness score for each of the one or more second properties; determining a projected change in price percentage in response to the sales data for the one or more first properties and the sales data for the one or more second properties; determining a first supply score in response the one or more first properties and the first selected time period; determining a second supply score in response to the one or more second properties and the second selected time period; and determining an estimated market clearing price for the desired property in response to an initial listing price of the desired property, the first supply score, the second supply score, and the projected change in price percentage.

In addition to one or more of the features described above, or as an alternative, further embodiments may include: sharing the estimated market clearing price with the buyer.

In addition to one or more of the features described above, or as an alternative, further embodiments may include: displaying a buy it now selectable button on the user device of the buyer when a list price of the desired property is about equal to the estimated market clearing price.

In addition to one or more of the features described above, or as an alternative, further embodiments may include: displaying a buy it now selectable button on the user device of the buyer when the estimated market clearing price is received by the buyer; receiving a selection input on the buy it now selectable button on the user device of the buyer; and transmitting an offer to a user device of a seller, wherein the offer includes the estimated market clearing price.

In addition to one or more of the features described above, or as an alternative, further embodiments may include: activating an alarm on the user device of the buyer when a list price of the desired property is about equal to the estimated market clearing price.

In addition to one or more of the features described above, or as an alternative, further embodiments may include: activating an alarm when a list price of the desired property is within a selected range of the estimated market clearing price.

In addition to one or more of the features described above, or as an alternative, further embodiments may include that prior to the obtaining the method further comprises: determining an average attractiveness score for one or more first properties sold in the search area in response to feedback received; and determining an average attractiveness score for one or more first properties sold in the search area in response to feedback received.

In addition to one or more of the features described above, or as an alternative, further embodiments may include that the determining an average attractiveness score further comprises: providing access to a real estate listing via a system including at least a listing recommendation server that communicates with a real estate feedback application; and receiving feedback regarding the real estate listing from a user device operating the real estate feedback application.

In addition to one or more of the features described above, or as an alternative, further embodiments may include that the receiving feedback regarding the real estate listing further comprises: receiving at least one of a picture, a video, and a note from the user device running the real estate feedback application.

In addition to one or more of the features described above, or as an alternative, further embodiments may include that the receiving feedback regarding the real estate listing further comprises: receiving a rating from the user device operating the real estate feedback application.

In addition to one or more of the features described above, or as an alternative, further embodiments may include that the rating is provided as a scale rating.

In addition to one or more of the features described above, or as an alternative, further embodiments may include that the scale rating is provided as at least one of numeric, emoji based, and color coded.

According to another embodiment, a listing recommendation server is provided. The listing recommendation server comprising: a processor; a memory comprising computer-executable instructions that, when executed by the processor, cause the processor to perform operations, the operations comprising: receiving a real estate price estimate request from a real estate application operating on a user device of the buyer, the real estate price estimate request including a desired property; determining a search area in response to a geographical location of the desired property; obtaining sales data for one or more first properties sold in the search area within a first selected time period, wherein the sales data includes an initial list price, a purchase price, and an average attractiveness score for each of the one or more first properties; obtaining sales data for one or more second properties sold in the search area within a second selected time period, wherein the sales data includes an initial list price, a purchase price, and an average attractiveness score for each of the one or more second properties; determining a projected change in price percentage in response to the sales data for the one or more first properties and the sales data for the one or more second properties; determining a first supply score in response the one or more first properties and the first selected time period; determining a second supply score in response to the one or more second properties and the second selected time period; and determining an estimated market clearing price for the desired property in response to an initial listing price of the desired property, the first supply score, the second supply score, and the projected change in price percentage.

In addition to one or more of the features described above, or as an alternative, further embodiments may include that the operations further comprise: sharing the estimated market clearing price with the buyer.

In addition to one or more of the features described above, or as an alternative, further embodiments may include that the operations further comprise: displaying a buy it now selectable button on the user device of the buyer when a list price of the desired property is about equal to the estimated market clearing price.

In addition to one or more of the features described above, or as an alternative, further embodiments may include that the operations further comprise: displaying a buy it now selectable button on the user device of the buyer when the estimated market clearing price is received by the buyer; receiving a selection input on the buy it now selectable button on the user device of the buyer; and transmitting an offer to a user device of a seller, wherein the offer includes the estimated market clearing price.

In addition to one or more of the features described above, or as an alternative, further embodiments may include that the operations further comprise: activating an alarm on the user device of the buyer when a list price of the desired property is about equal to the estimated market clearing price.

In addition to one or more of the features described above, or as an alternative, further embodiments may include that the operations further comprise: activating an alarm when a list price of the desired property is within a selected range of the estimated market clearing price.

In addition to one or more of the features described above, or as an alternative, further embodiments may include that prior to the obtaining the operations further comprises: determining an average attractiveness score for one or more first properties sold in the search area in response to feedback received; and determining an average attractiveness score for one or more first properties sold in the search area in response to feedback received.

In addition to one or more of the features described above, or as an alternative, further embodiments may include that the determining an average attractiveness score further comprises: providing access to a real estate listing via a system including at least a listing recommendation server that communicates with a real estate feedback application; and receiving feedback regarding the real estate listing from a user device operating the real estate feedback application.

Technical effects of embodiments of the present disclosure include a real estate system configured to estimate a price of a property based upon past sales of properties in the area and the attractiveness value of the each of the properties previously sold.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION

The following descriptions should not be considered limiting in any way. With reference to the accompanying drawings, like elements are numbered alike:

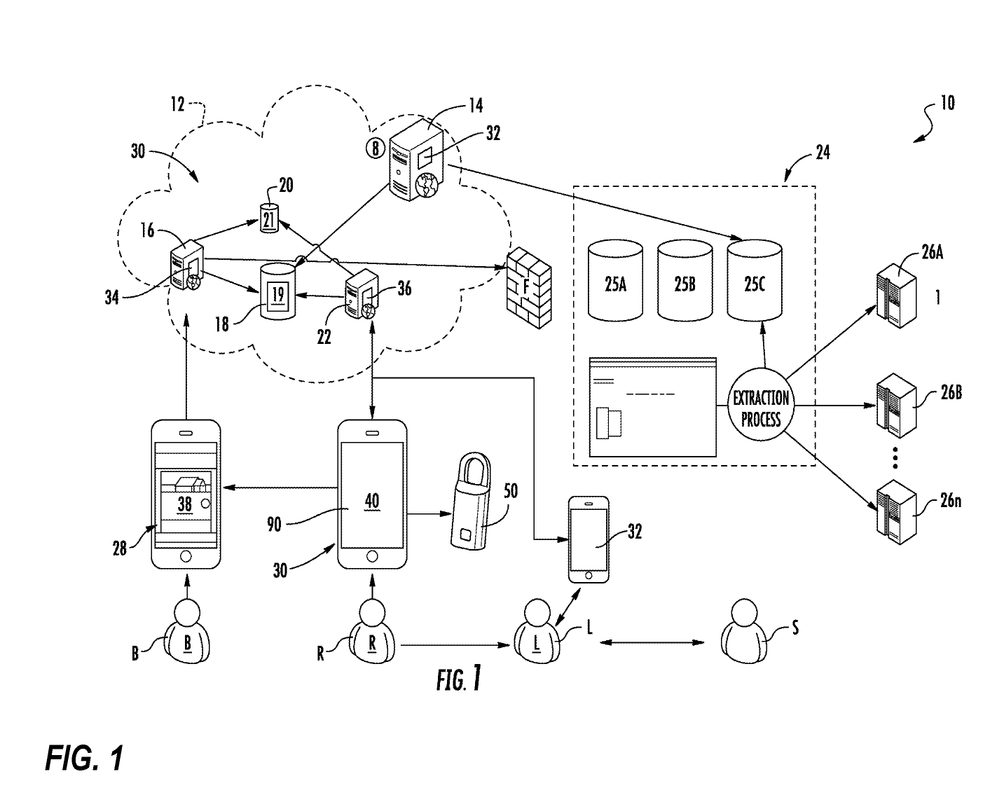

FIG. 1 illustrates a general schematic system diagram of a real estate application system, in accordance with an embodiment of the disclosure;

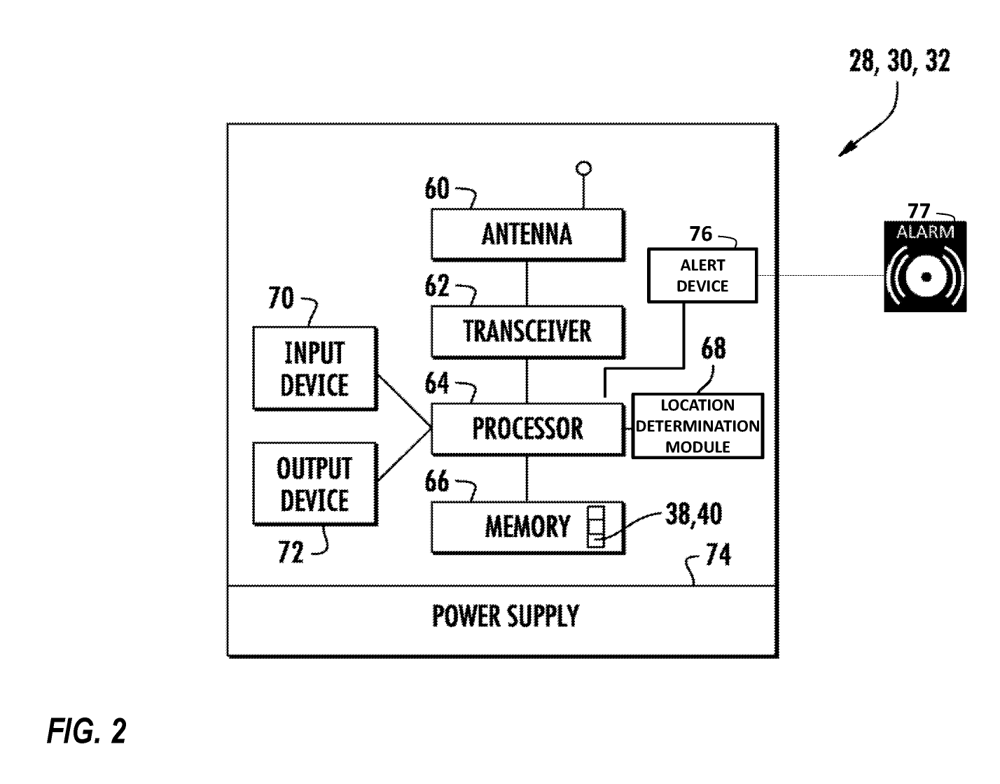

FIG. 2 illustrates a general schematic system diagram of a user device, in accordance with an embodiment of the disclosure;

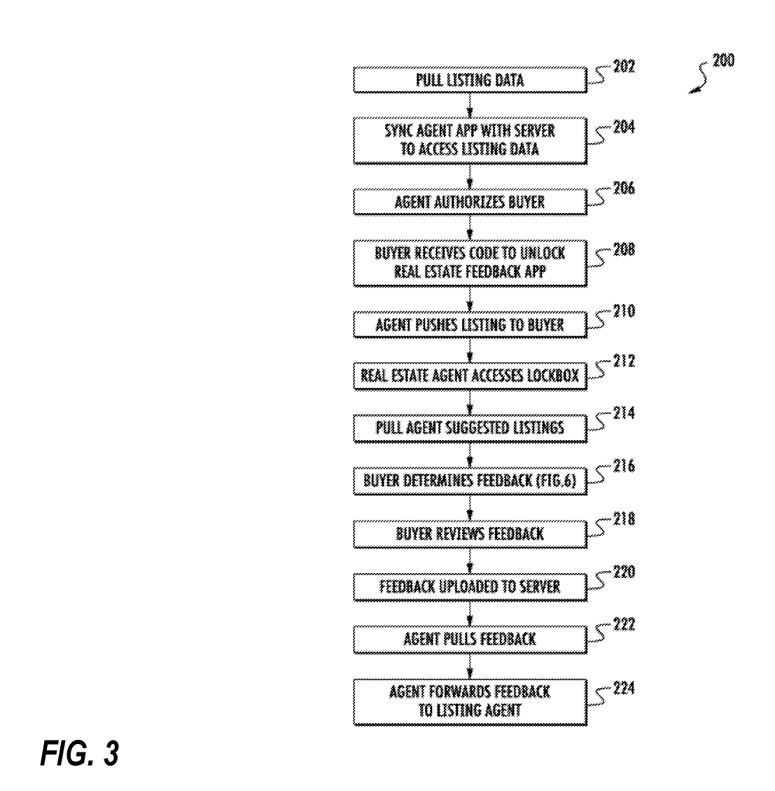

FIG. 3 illustrates a flowchart of a method to provide feedback for real estate, with the system of FIG. 1, in accordance with an embodiment of the disclosure;

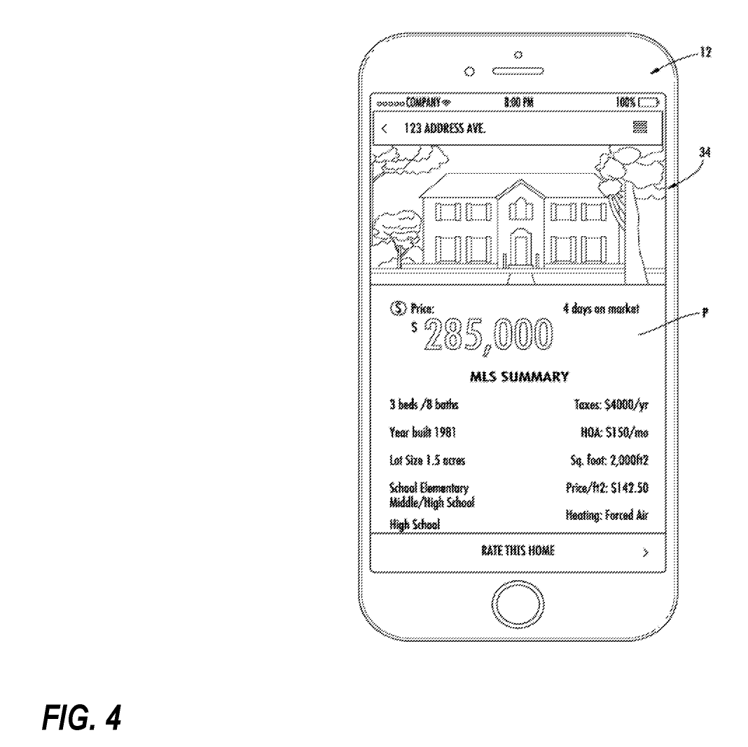

FIG. 4 illustrates a screenshot of the real estate application property listing view, in accordance with an embodiment of the disclosure;

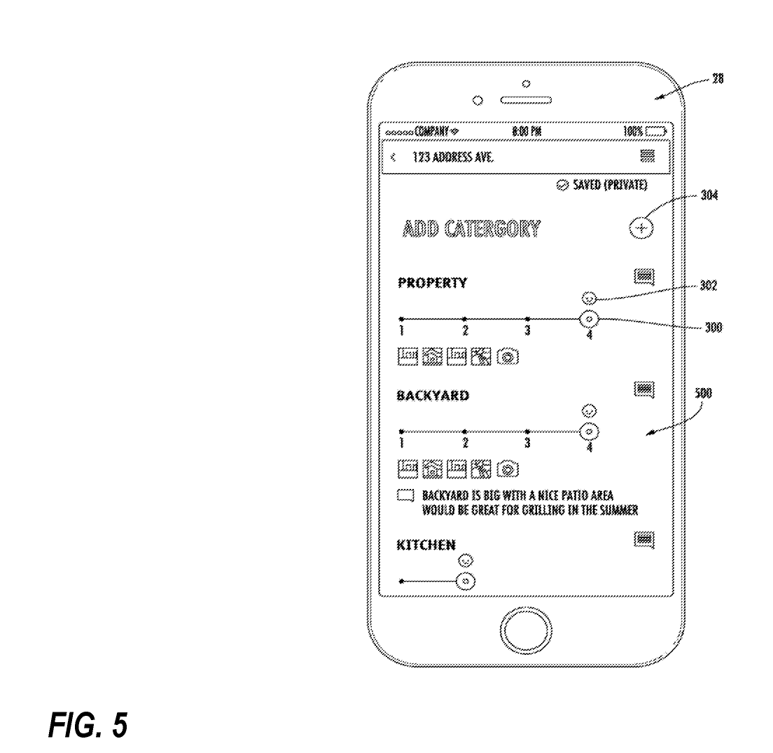

FIG. 5 illustrates a screenshot of the real estate application feedback view, in accordance with an embodiment of the disclosure;

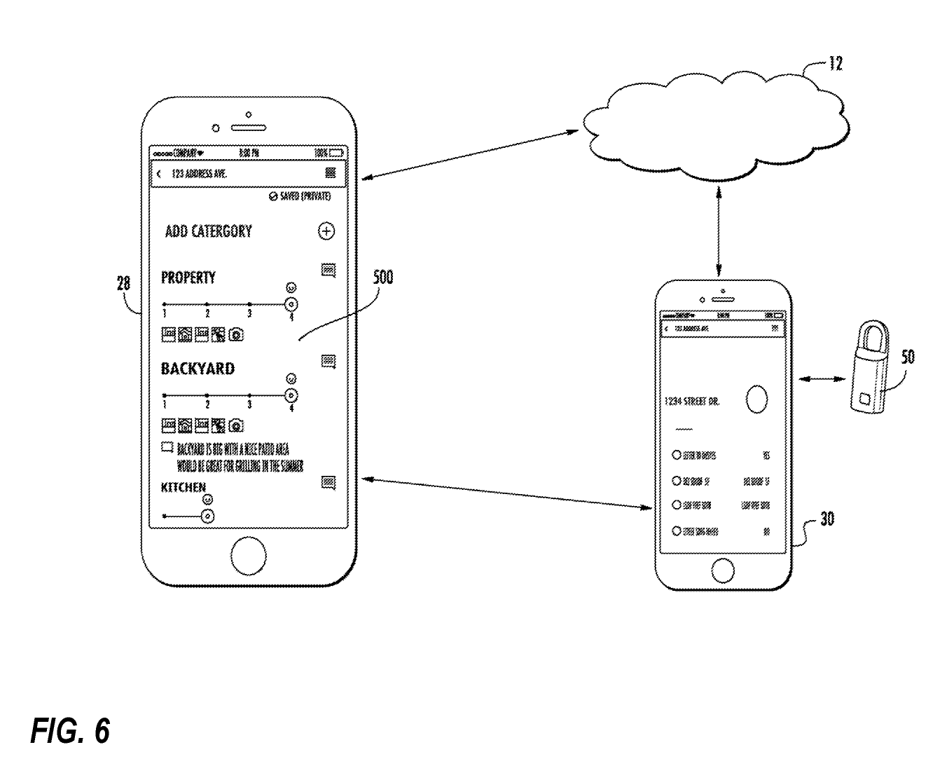

FIG. 6 illustrates a schematic diagram of a system to provide feedback for real estate which is a portion of the system of FIG. 1, in accordance with an embodiment of the disclosure;

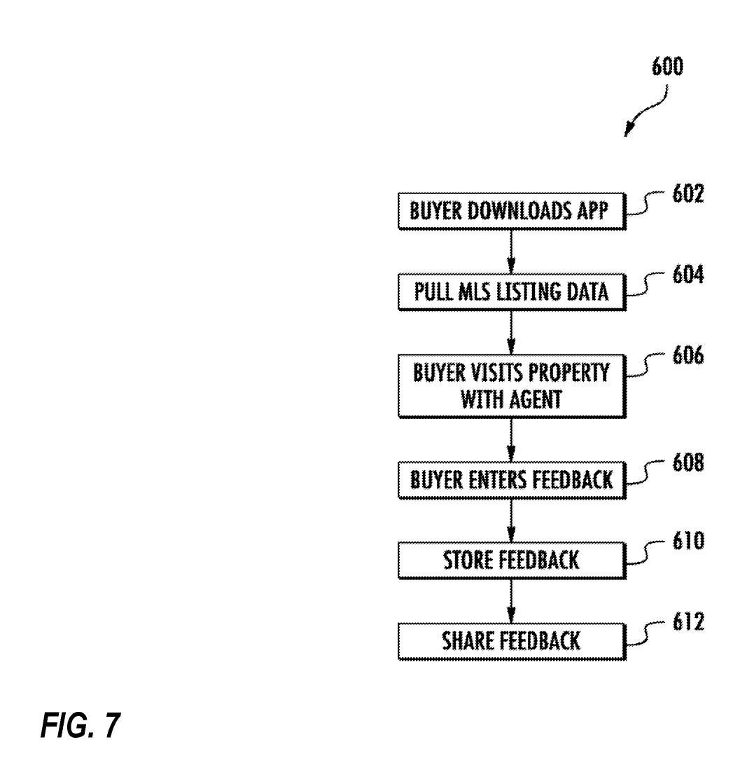

FIG. 7 illustrates a flowchart to provide feedback from a buyer's user device, in accordance with an embodiment of the disclosure;

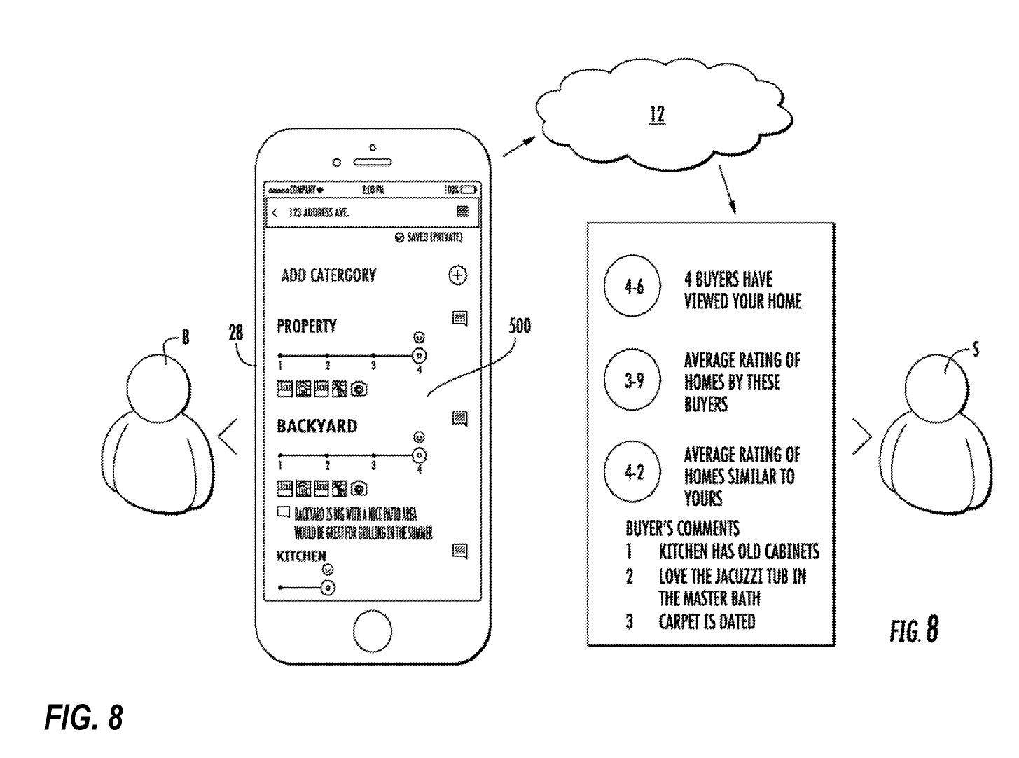

FIG. 8 illustrates a schematic block diagram of feedback provided from a buyer's user device to a seller, in accordance with an embodiment of the disclosure;

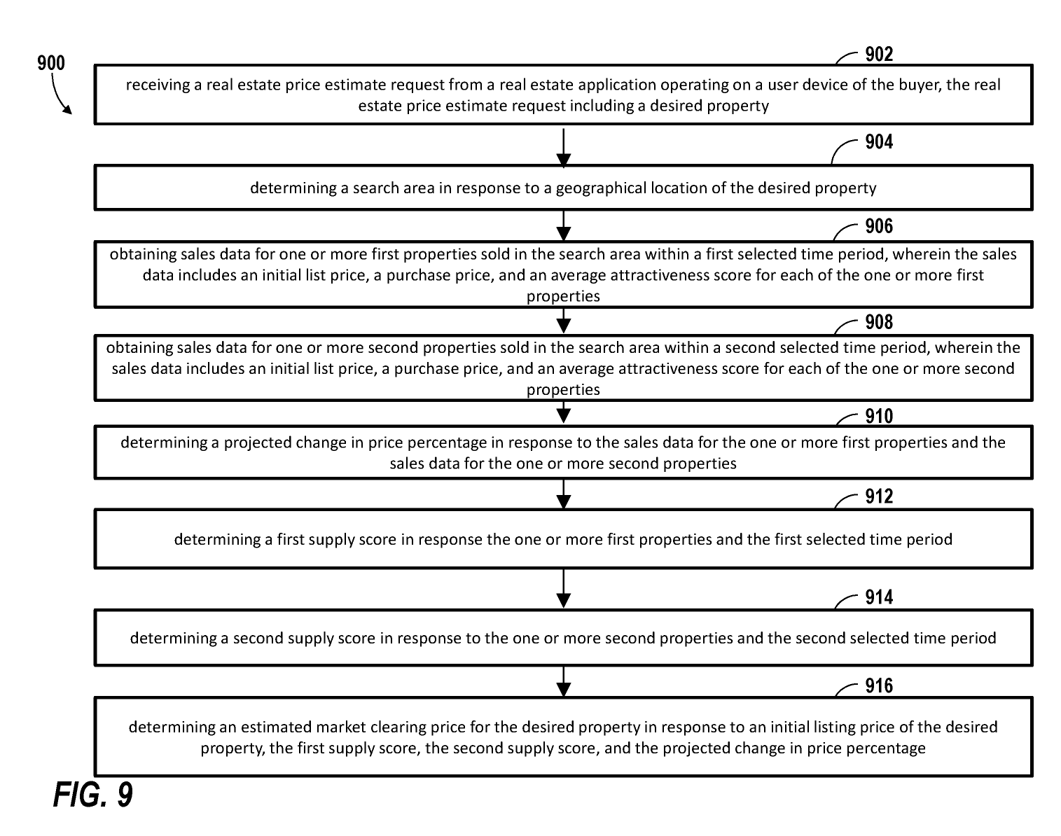

FIG. 9 illustrates a flow diagram illustrating a method of estimating a price for a desired property, according to an embodiment of the present disclosure; and

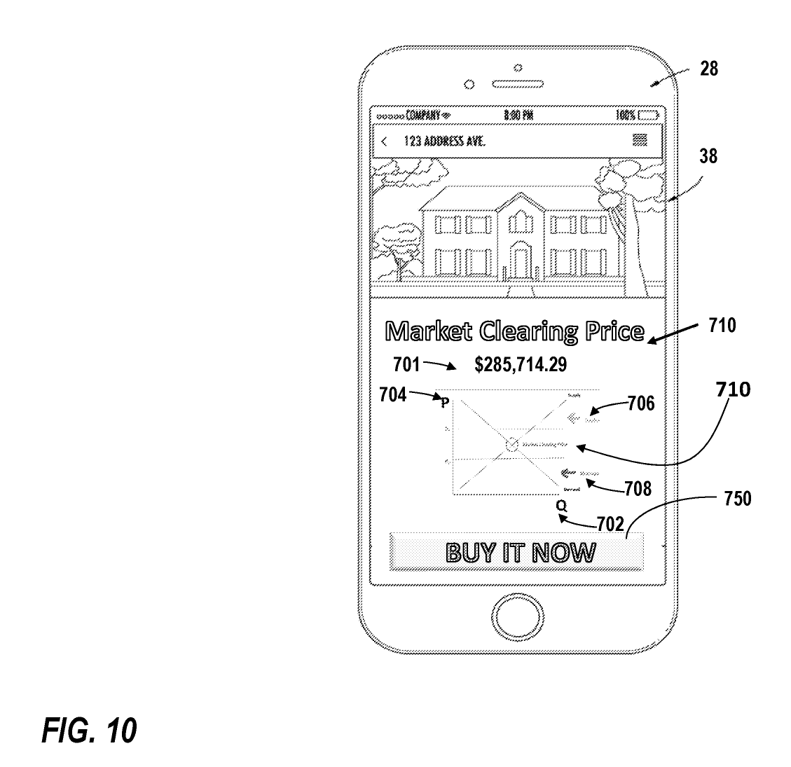

FIG. 10 illustrates a screenshot of the real estate application market clearing price view, in accordance with an embodiment of the disclosure.

### DETAILED DESCRIPTION

A detailed description of one or more embodiments of the disclosed apparatus and method are presented herein by way of exemplification and not limitation with reference to the Figures.

FIG. 1 schematically illustrates a system 10 to facilitate communication for real estate transactions. A showing agent “R” has a fiduciary duty to a home buyer “B” while a listing agent “L” has a fiduciary duty to a home seller “S.” The showing agent “R” typically shows the property to the home buyer “B.” The listing agent “L” typically communicates with the buyer “B” only indirectly, such as by communication with the showing agent “R” who then communicates information to and from the buyer “B.” Although only particular agents are referred to in the illustrated embodiments, the functions of such personnel may be otherwise assigned or rearranged. For example, the listing agent “L” may utilize a seller's assistant.

Showing information is accessible through the system 10 so that the listing agent “L” can generate reports for their seller “S”, send updates about a particular listing to showing agents “R” who recently showed that listing. Data generated by an electronic key box 50 may depict information on showings, such as number of showings, time spent at the subject property, return showings, etc. Listing agents “L” may also use the system 10 to receive automatic notification (e.g., email notices) when a showing occurs at their listings. The buyer “B” may also benefit as the system 10 provides a central repository for buyer information (e.g., details of each home the buyer has viewed). A buyer “B” may review properties through a real estate application 38 on a user device 28. A buyer “B” may also rate each property through the real estate application 38. The rating may rate various aspects of the property in order to generate an average attractiveness score, which may be an average of each rating from multiple different buyers.

The system 10 generally includes a subsystem 12 that may be controlled by a single owner. The subsystem 12 generally includes a listing recommendation server 14, a buyer server 16, a buyer database system 18, a log database system 20, and an electronic key server 22. A multiple of user devices 28, 30, 32, communicate with the subsystem 12. The first user device 28 is herein associated with the potential buyer “B,” the second user device 30 is associated with the showing agent “R” and the third user device 32 is associated with the listing agent L.

“Server” conveys its customary meaning and further includes a corporate datacenter that provides service and/or data connection, e.g., to the user device and/or an electronic locking device.

The “user device” may be a non-portable computing device such as a desktop computer. The “user device” may also refer to a portable electronic computing device that is at least configured to send messages to, and/or receive messages from the listing recommendation server 14 over a long-range wireless communication network, such as a SMS, wireless, or cellular network. Examples of user devices include, but are not limited to: a cell phone; a personal digital assistant (“PDA”); a portable computer configured to store and playback digital pictures, songs, and/or videos; and the like. In addition, the user device is typically also configured for short-range wireless communications. The “user device” may also be two separate devices that are synced together such as, for example, a cellular phone and a desktop computer synced over an internet connection.

The listing recommendation server 14 communicates with the buyer database system 18, the log database system 20, and a data center 24. The buyer database system 18 includes a database 19 that stores rating and notes taken by the buyer “B,” and the log database system 20 includes a database 21 that collects activity data. The buyer data base system 18 may also store property variables, selected multipliers for each property variable, a real estate search request, a desired location of the real estate search, and a current residence of the buyer “B”, all of which are discussed in further detail below. The data center 24 may host one or more servers that may include, but not be limited to, a database for managing key holders 25A, a security database 25B that hosts security protocols, and a listing database 25C that stores extracted real estate listings from external servers 26A, 26B, 26N. The real estate listing is the description of a property via a system, such as for example an application, a website, or similar apparatus known to one of skill in the art.

The data center 24 communicates with the external data servers 26A-26N such as a Real Estate Transaction Standard (RETS) framework that stores MLS data. The MLS data includes information such as number of bedrooms, number of bathrooms, price of listing, etc. RETS is a framework that can be adopted by computer systems to receive data from the Multiple Listing Service (MLS) servers, as well as those of other real estate systems provided they also have software installed designed to communicate using the RETS framework. The National Association of Realtors refers to RETS as a “common language.” The data center 24 may also host real estate servers including a database for managing key box inventories, a security database that houses security protocols, a listing database of property listings, and/or other databases.

The listing recommendation server 14 hosts, for example, at least an analytics software application 32 that compiles and runs analytics against MLS listing data from the data center 24. The buyer server 16 hosts a buyer application program interface (API) 34, and the electronic key server 22 hosts an electronic key API 36. An application program interface (API) is a set of routines, protocols, and tools for building software applications. An API specifies how software components should interact. APIs are used when programming graphical user interface (GUI) components. A server-side web API is a programmatic interface consisting of one or more publicly exposed endpoints to a defined request-response message system

The listing recommendation server 14 communicates with a real estate application 38 on the user device 28 through the buyer API 34 and buyer database system 18. An agent application 40 on the user device 30 communicates with the listing recommendation server 14 and the electronic key server 22. The buyer API 34 and the electronic key API 36 also communicate with the data center 24 through a firewall “F” or other security protocol.

The real estate application 38 may be a mobile application that may be used by the home buyer “B” to rate the properties they have seen via, for example, recordation of feedback and cataloging of the properties of interest. The real estate application 38 may be a mobile application that may be used by the home buyer “B” to enter property variables, selected multipliers for each property variable, the real estate search request, the desired location of the real estate search, and the current residence of the buyer “B”. The real estate application 38 communicates with the buyer database system 18 through the buyer API 34 which then stores the ratings, notes, property variables, selected multipliers for each property variable, the real estate search request, the desired location of the real estate search, and the current residence of the buyer “B” in the buyer database system 18.

The agent application 40 may be a mobile application that may be used by the showing agent “R” to access the electronic key boxes 50. The electronic key API 36 communicates with the agent application 40 to sync activity from the electronic key boxes 50 to the electronic key API 36 (e.g., key boxes the key has opened), and showing notifications (e.g., messages about accessed key boxes and associated showing agent “R”).

With reference to FIG. 2, each user device 28, 30, 32, generally includes a user device antenna 60, a user device transceiver 62, a user device processor 64, a user device memory 66, a location determination module 68, an input device 70, a display 72, an alert device 76, and a user device power supply 74. The user device processor 64 may be any type of microprocessor having desired performance characteristics. The user device memory 66 may include any type of computer readable medium that stores the data and executable instructions described herein below. The executable instructions may be stored or organized in any manner and at any level of abstraction, such as in connection with one or more applications, processes, routines, procedures, methods, etc. The user device transceiver 62 is a transceiver of a type corresponding to the transceiver 62 and the user device antenna 60 is a corresponding antenna. The location determination module 68 may be a GPS module in a non-limiting example. The alert device 76 is configured to activate an alarm 77. In three non-limiting examples, the alert device 76 may be a vibration motor, audio speaker, and/or display screen. The alarm 77 may be audible, visual, haptic, and/or vibratory.

With reference to FIG. 3, a method 200 for operation of the system 10 is disclosed in terms of functional block diagrams. The functions are programmed software routines capable of execution in various microprocessor based electronics control embodiments and represented herein as block diagrams.

Initially, the owner of the subsystem 12 may have agreements with MLS to selectively extract (202) MLS data from the external data servers 26A-26N (FIG. 1) into the listing recommendation server 14. Next, the agent application 40 syncs (204) with the listing recommendation server 14 and pulls MLS data for desired listings. This may be performed through an automated sync through the agent application 40. The showing agent “R” may also do a manual sync to obtain updated MLS data.

Through the agent application 40, the showing agent “R” can authorize (206) the home buyer “B” to access the desired listings of interest to the buyer “B”. Through the agent application 40, the showing agent “R” authorizes the buyer “B” through input of buyer identification information (e.g., name and email address.) The buyer identification information is then synced with the listing recommendation server 14. The listing recommendation server 14 then communicates with the buyer “B” (e.g., via email) that can include a link to an app store and a code to unlock (208) the real estate application 38. The buyer “B” is then authorized to download the real estate application 38 and desired listings, or to maintain the value of the showing agent “R” in the real estate transaction.

Through the agent application 40, the showing agent “R” can continue to push (210) listings to the real estate application 38. Access may be provided for one or more properties by a showing code, or other link to unlock one or more features in the real estate application 38. The showing agent “R” is able to selectively push properties (one example property illustrated by screenshot “P”; FIG. 4) to be viewable within the real estate application 38. The showing agent “R” also uses the agent application 40 to operate the electronic key box 50 to access the property for showing to the buyer “B.”

Next, during the showing, feedback is entered into the real estate feedback application 500 by the buyer “B” for the property (step 216; FIG. 5 and FIG. 6) as further discussed below. The feedback may include any data that can be later used for reviewing and comparing properties. The real estate feedback application 500 may be a module of the real estate application 38, and/or other application.

In addition to the features discussed above, the buyer “B” can utilize the real estate feedback application 500 to record feedback for each property visited. In one embodiment, the buyer “B” can take pictures, videos, and/or notes during the property showing. In another embodiment, the feedback may be provided as a scale rating (FIG. 5). For example, the scale rating may be numeric 300 (e.g., 1-10), emoji based 302 (e.g., happy face, sad face), color coded (e.g., red, yellow, green), or other such ranking. Further, the rating may be specific to particular rooms of the property, (e.g., overall property, backyard, kitchen, etc.) and/or features, (e.g., appliances, fixtures, etc.). In another embodiment, the buyer is prompted for feedback. In another embodiment, the buyer is prompted for feedback based on the location of the buyer within the property (e.g., via global positioning of the buyer within the property by way of the GPS module 68 (FIG. 2)) such that when the buyer enters, for example, the kitchen, the real estate feedback application 500 prompts the buyer for feedback on the kitchen, etc. In still another embodiment, the buyer can add a category 304 to provide feedback thereon (e.g., garage).

The feedback is then saved in memory 66 (FIG. 2) via the real estate feedback application 500 so that the buyer can review at a later time (step 218). The feedback can also be used to compare properties reviewed by the buyer.

As the buyer generates feedback about the listing, the real estate feedback application 500 uploads this data to the buyer API 20 (step 220; FIG. 1). Once the showing is complete, the buyer can decide to share the ratings with their showing agent “R” via the real estate feedback application 500 which authorizes the listing recommendation server to release the ratings 14 from the buyer database 19.

The agent application 40 then syncs with the listing recommendation server 14 and downloads the feedback (step 222). The showing agent “R” is then able to review ratings and comments on the agent application 40.

Through the agent application 40, the showing agent “R” can communicate the feedback to the listing agent “L” (step 224). In one embodiment, the feedback may be forwarded through an email app on the user device 30, and need not be through the subsystem 12. For example, an email app resident on the user device 30 is called by the agent application 40, and the feedback is automatically copied into the email body. The showing agent “R” may then edit the email body prior to sending the feedback to the listing agent “S.”

With reference to FIG. 7, a method 600 for providing feedback via the real estate feedback application 500 from the perspective of the buyer “B” is disclosed in terms of functional block diagrams. The functions are programmed software routines and executable instructions capable of execution in various microprocessor based electronics control embodiments and represented herein as block diagrams.

Initially, the buyer “B” downloads the real estate feedback application 500 from a source such as an app store (step 602). The real estate feedback application 500 communicates (step 604) with the listing recommendation server 14 via the buyer API 34 to pull the agent selected MLS listings. The showing agent “R” then typically escorts the buyer “B” for a showing of particular properties selected by the buyer (step 606). Next, the feedback is entered (step 608; FIG. 5) into the real estate feedback application 500 by the buyer “B” for the particular property. The feedback is then saved via the real estate feedback application 500 so that the buyer “B” can review at a later time (step 610). The real estate feedback application 500 can be used by the buyer “B” to review feedback and compare notes on the properties.

Once the showing is complete, the buyer can choose to share the ratings with their showing agent “R” (step 612). If they choose to do so, the real estate feedback application 500 will send a message to the listing recommendation server 14 though the buyer API 20 to release the ratings to the showing agent “R.” The feedback may be provided to the listing agent “L” through the subsystem 12. In this embodiment, the real estate feedback application 500 uploads the feedback data from the buyer database 18 to the electronic key server 22 via the buyer API 34 which then generates a report for the listing agent “L” (FIG. 8). The report may include the feedback in a format that may include, but not be limited to, this particular buyer's feedback (i.e., does the buyer like the property?), this particular buyer's feedback as compared to other properties (i.e., how serious is the buyer about the property?), other buyer's feedback comparison for the particular property (i.e., is this a likely buyer?) and/or other buyer's feedback for other properties (i.e., how does the particular property compare with other properties?)

The system and method provides a seller with access to relevant buyer feedback and buyers with a tool for managing properties they visit.

The feedback may be used to generate an average attractiveness rating from multiple buyers “B” for the property. The average attractiveness rating may be an average of the feedback enter by each buyer “B” who visits the property. In an alternative embodiment, the average attractiveness rating may be also determined by crowd sourcing, where users may rank properties remotely through an online application.

Referring now to FIGS. 9 and 10, with continued reference to FIGS. 1-8. FIG. 9 shows a flow chart of method 900 of estimating a price for a desired property (market clearing price 710), in accordance with an embodiment of the present disclosure. At block 902, a real estate price estimate request from a real estate application 38 operating on a user device 28 of the buyer “B” is received. The real estate price estimate request includes a desired property, as identified by the buyer. At block 904, a search area is determined in response to a geographical location of the desired property. The search area may be a geographical radius around the geographical location of the desired property, a zip code of the desired property, and/or a customizable area selected by the buyer “B” through the real estate application 38 operating on a user device 28. The customizable area may be area drawn around the geographical location of the desired property by the buyer “B” through the real estate application 38 on the user device 28.

At block 906, sales data is obtained for one or more first properties sold in the search area within a first selected time period. The sales data may include an initial list price, a purchase price, and an average attractiveness score for each of the one or more first properties. At block 908, sales data is obtained for one or more second properties sold in the search area within a second selected time period. The sales data may include an initial list price, a purchase price, and an average attractiveness score for each of the one or more second properties.

At block 910, a projected change in price percentage (% ALP) is determined in response to the sales data for the one or more first properties and the sales data for the one or more second properties. The projected change in price percentage (% ALP) is determined by taking the average of the percentage of change in price for each attractiveness score for the one or more first properties and the one or more second properties.

TABLE 1
Example of Projected Change in Price
Percentage (% ΔLP) Determination

| | | | | Average |
|---|---|---|---|---|
| | List | Purchase | Change | Attractiveness |
| Property | Price | Price | in Price | Score |
| Property 1 | $200,000 | $195,000 | −2.5% | 8.5 |
| Property 2 | $280,000 | $300,000 | 7.14% | 9.8 |
| Property 3 | $300,000 | $275,000 | −8.3% | 7.6 |

Projected Change in Price Percentage(% ΔLP)

At block 912, a first supply score (SupplyScore₁) is determined in response the one or more first properties and the first selected time period. At block 914, a second supply score (SupplyScore₂) is determined in response to the one or more second properties and the second selected time period. The first supply score (SupplyScore₁) and second supply score (SupplyScore₂) are determined using a first equation (i) shown below. As shown by the first equation (i), the supply score (SupplyScoreᵢ) is determined by dividing a statistically significant sample of properties sold by the time period that which the properties were sold.

$$Supply {Score}_{i} = ( \frac{( Statistically Significiant Sample of Properties Sold )}{( Time Period of Sales )} ) \qquad ( i )$$

In one example, a statistically significant sample of properties would be 384 properties for a confidence level of 95%, a confidence interval of 5%, and a population of 5.8 million (number of properties sole in US in 2016), thus the supply score would be 384 divided by 1 year, which would equal 384. Using a current date, the Time Period of Sales is determined by a start date of Statistically Significant Sample of Properties Sold. For example, starting with Supply Score₂ if the current date was Jul. 1, 2017, the statistically significant sample of properties is 384, and between Jan. 1, 2017 and Jul. 1, 2017 384 properties were sold then the time period for Supply Score₂ would be from Jan. 1, 2017 to Jul. 1, 2017 (i.e. 6 months). Supply Score₁ would then be calculated with Dec. 31, 2016 as the end date for the time period of sales for Supply Score₁ and the beginning date would be the first date that 384 instances of properties were sold between the beginning and the end date. If between Jan. 1, 2016 and Dec. 31, 2016 384 properties were sold than the end date would Jan. 1, 2016 and the time period of sales for Supply Score₁ would be 12 months (1 year). Two different supply scores are determined to later be used for determining an estimate market clearing price 710 at block 916 below.

At block 916, an estimated market clearing price 710 is determined for the desired property in response to an initial listing price of the desired property, the first supply score (SupplyScore₁), the second supply score (SupplyScore₂), and the projected change in price percentage (% ALP). The estimated market clearing price 710 is determined using a second equation (ii), shown below.

$$Estimated Market Clearing Price = {Property}_{x} {LP}_{initial} * ( 1 + ( \frac{( \% Δ LP )}{( \frac{{SupplyScore}_{2}}{{SupplyScore}_{1}} )} ) ) \qquad ( ii )$$

In Table 2, shown below, an estimated market clearing price 710 is determined using the equation (ii) shown below.

TABLE 2
Example of Market Clearing Price Determination

| Variable for Property 1 | Value |
|---|---|
| List Price (PropertyₓLPᵢₙᵢₜᵢₐₗ) | $250,000 |
| Projected change in price percentage (% ΔLP) | 7.14% |
| Attractiveness Score | 9.8 |
| Supply Score 1 (SupplyScore₁) | 384 |
| Supply Score 2 (SupplyScore₂) | 192 |
| Estimated Market Clearing Price | $285,714.29 |

Once a market clearing price 710 is determined, the market clearing price 710 may be shared with the buyer “B” by transmitting the market clearing price 710 to the real estate application 38 operating on a user device 28 of the buyer “B”. The market clearing price 710 may be displayed on the user device 28 of the buyer “B” through the real estate application 38 when the market clearing price 710 is received, as shown by FIG. 10.

The market clearing price 710 may be displayed on a graph 701, as shown in FIG. 10. The graph 710 may be a price 704 versus quantity 702 graph illustrating supply versus demand of the housing marking in the selected area around the desired property. The graph 701 may include limit lines 706, 708 illustrating when there is a surplus of properties shown by the surplus limit line 706 and a shortage of properties shown by the shortage limit line 708. The market clearing price 710 may lie in between the surplus limit line 706 and the shortage limit line 708, as seen in FIG. 10.

An alarm 77 may be activated on the user device 28 of the buyer “B” through the real estate application 38 when the market clearing price 710 is received. An alarm 77 may also be activated on the user device 28 of the buyer “B” through the real estate application 38 when a list price of the desired property is equal to the market clearing price 710. An alarm 77 may further be activated on the user device 28 of the buyer “B” through the real estate application 38 when a list price of the desired property is within a selected range of the market clearing price 710.

A “buy it now” button 750 may be displayed on the user device 28 of the buyer “B” through the real estate application 38 when the market clearing price 710 is determined, if both the buyer “B” and the seller “S” agree in advance to sell/buy, respectively, for the market clearing price 710 eventually determined. Also “buy it now” button 750 may be displayed on the user device 28 of the buyer “B” through the real estate application 38 when a list price of the desire property is about equal to the market clearing price 710 determined. When the buyer selects the “buy it now” button 750 through a selection input (i.e. tough, tap, click, . . . , etc.) then an offer may be transmitted to a user device of the seller “S” of the desired property and/or a user device 32 of the listing agent “L” for the seller “S” of the desired property. The offer may include an offer to buy the desired property at the market clearing price 710.

While the above description has described the flow process of FIG. 9 in a particular order, it should be appreciated that unless otherwise specifically required in the attached claims that the ordering of the steps may be varied.

As described above, embodiments can be in the form of processor-implemented processes and devices for practicing those processes, such as a processor. Embodiments can also be in the form of computer program code containing instructions embodied in tangible media, such as network cloud storage, SD cards, flash drives, floppy diskettes, CD ROMs, hard drives, or any other computer-readable storage medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into an executed by a computer, the computer becomes an device for practicing the embodiments. When implemented on a general-purpose microprocessor, the computer program code segments configure the microprocessor to create specific logic circuits.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A method of estimating a price for a desired property, the method comprising:
receiving a real estate price estimate request from a real estate application operating on a user device of the buyer, the real estate price estimate request including a desired property;
determining a search area in response to a geographical location of the desired property;
obtaining sales data for one or more first properties sold in the search area within a first selected time period, wherein the sales data includes an initial list price, a purchase price, and an average attractiveness score for each of the one or more first properties;
obtaining sales data for one or more second properties sold in the search area within a second selected time period, wherein the sales data includes an initial list price, a purchase price, and an average attractiveness score for each of the one or more second properties;
determining a projected change in price percentage in response to the sales data for the one or more first properties and the sales data for the one or more second properties;
determining a first supply score in response the one or more first properties and the first selected time period;
determining a second supply score in response to the one or more second properties and the second selected time period; and
determining an estimated market clearing price for the desired property in response to an initial listing price of the desired property, the first supply score, the second supply score, and the projected change in price percentage.

2. The method of claim 1, further comprising:
sharing the estimated market clearing price with the buyer.

3. The method of claim 2, further comprising:
displaying a buy it now selectable button on the user device of the buyer when a list price of the desired property is about equal to the estimated market clearing price.

4. The method of claim 2, further comprising:
displaying a buy it now selectable button on the user device of the buyer when the estimated market clearing price is received by the buyer;
receiving a selection input on the buy it now selectable button on the user device of the buyer; and
transmitting an offer to a user device of a seller, wherein the offer includes the estimated market clearing price.

5. The method of claim 1, further comprising:
activating an alarm on the user device of the buyer when a list price of the desired property is about equal to the estimated market clearing price.

6. The method of claim 1, further comprising:
activating an alarm when a list price of the desired property is within a selected range of the estimated market clearing price.

7. The method of claim 1, wherein prior to the obtaining the method further comprises:
determining an average attractiveness score for one or more first properties sold in the search area in response to feedback received; and
determining an average attractiveness score for one or more first properties sold in the search area in response to feedback received.

8. The method of claim 7, wherein the determining an average attractiveness score further comprises:
providing access to a real estate listing via a system including at least a listing recommendation server that communicates with a real estate feedback application; and
receiving feedback regarding the real estate listing from a user device operating the real estate feedback application.

9. The method of claim 8, wherein the receiving feedback regarding the real estate listing further comprises:
receiving at least one of a picture, a video, and a note from the user device running the real estate feedback application.

10. The method of claim 8, wherein the receiving feedback regarding the real estate listing further comprises:
receiving a rating from the user device operating the real estate feedback application.

11. The method of claim 10, wherein:
the rating is provided as a scale rating.

12. The method of claim 11, wherein:
the scale rating is provided as at least one of numeric, emoji based, and color coded.

13. A listing recommendation server comprising:
a processor;
a memory comprising computer-executable instructions that, when executed by the processor, cause the processor to perform operations, the operations comprising:
receiving a real estate price estimate request from a real estate application operating on a user device of the buyer, the real estate price estimate request including a desired property;
determining a search area in response to a geographical location of the desired property;
obtaining sales data for one or more first properties sold in the search area within a first selected time period, wherein the sales data includes an initial list price, a purchase price, and an average attractiveness score for each of the one or more first properties;
obtaining sales data for one or more second properties sold in the search area within a second selected time period, wherein the sales data includes an initial list price, a purchase price, and an average attractiveness score for each of the one or more second properties;
determining a projected change in price percentage in response to the sales data for the one or more first properties and the sales data for the one or more second properties;
determining a first supply score in response the one or more first properties and the first selected time period;
determining a second supply score in response to the one or more second properties and the second selected time period; and
determining an estimated market clearing price for the desired property in response to an initial listing price of the desired property, the first supply score, the second supply score, and the projected change in price percentage.

14. The listing recommendation server of claim 13, wherein the operations further comprise:
sharing the estimated market clearing price with the buyer.

15. The listing recommendation server of claim 14, wherein the operations further comprise:
displaying a buy it now selectable button on the user device of the buyer when a list price of the desired property is about equal to the estimated market clearing price.

16. The listing recommendation server of claim 14, wherein the operations further comprise:
displaying a buy it now selectable button on the user device of the buyer when the estimated market clearing price is received by the buyer;
receiving a selection input on the buy it now selectable button on the user device of the buyer; and
transmitting an offer to a user device of a seller, wherein the offer includes the estimated market clearing price.

17. The listing recommendation server of claim 13, wherein the operations further comprise:
activating an alarm on the user device of the buyer when a list price of the desired property is about equal to the estimated market clearing price.

18. The listing recommendation server of claim 13, wherein the operations further comprise:
activating an alarm when a list price of the desired property is within a selected range of the estimated market clearing price.

19. The listing recommendation server of claim 13, wherein prior to the obtaining the operations further comprises:
determining an average attractiveness score for one or more first properties sold in the search area in response to feedback received; and
determining an average attractiveness score for one or more first properties sold in the search area in response to feedback received.

20. The listing recommendation server of claim 19, wherein the determining an average attractiveness score further comprises:
providing access to a real estate listing via a system including at least a listing recommendation server that communicates with a real estate feedback application; and
receiving feedback regarding the real estate listing from a user device operating the real estate feedback application.
